(19) United States
(12) Patent Application Publication
(10) Pub. No.: US 2012/0145093 A1
(43) Pub. Date: Jun. 14, 2012

(54) Animal Medical Collar

(76) Inventor: Michael Anthony Martinez, Albuquerque, NM (US)

(21) Appl. No.: 12/964,309

(22) Filed: Dec. 9, 2010

(51) Int. Cl. A01K 27/00

(52) U.S. Cl. 119/863

(57) ABSTRACT

An animal medical collar having the shape of a circular, assembled around the neck of the animal by joining face-to-face to make a truncated cone shell whose edge, which is defined by the small circle of the truncated cone, engages the neck of the animal, further comprising a drawstring passage, and an internal frame comprising a curvilinear C-shaped hub and a plurality of substantially rigid straight ribs monolithically radially extending from the curvilinear hub.

### CROSS-REFERENCE TO RELATED APPLICATIONS

Not applicable.

### STATEMENTS REGARDING FEDERALLY SPONSORED RESEARCH AND DEVELOPMENT

Not applicable.

### BACKGROUND

The embodiments of the present invention satisfy the needs of having an animal medical collar.

Information relevant to attempts to address these problems can be found in U.S. Pat. Nos. 5,133,295; 5,197,414; 5,797,534; and D506,296; which are not admitted to be prior art with respect to the present invention by its mention in this Background Section. However, it is desirable to have a better device than is disclosed in the references.

U.S. Pat. No. 5,133,295 uses a non-resilient material, lacks an internal frame or stays, and is made from rings rather than disks cut to form a truncated cone.

U.S. Pat. No. 5,197,414 discloses a disk to form a truncated cone, but it uses a reticulated material and as such is not disposed for an internal frame or stays. Neither does it have a drawstring passage.

U.S. Pat. No. 5,797,534 discloses a disk to form a truncated cone, but it uses a “web of flexible material” rather than joining two disks face-to-face to contain an internal frame or stays. Neither does it have a drawstring passage.

U.S. Pat. No. D506,296 discloses a disk to form a truncated cone, but it uses a single layer of material rather than joining two disks face-to-face to contain an internal frame or stays. Neither does it have a drawstring passage.

The All Four Paws® Comfy Cone® comprises nylon fabric laminated onto ½ inch foam. It lacks an internal frame or stays.

The present invention is of the species described in U.S. Pat. No. 5,797,5354, namely a collar having the shape of a circular ring or circular ring sector, assembled around the neck of the animal by joining face-to-face to make a truncated cone shell whose edge, which is defined by the small circle of the truncated cone, engages the neck of the animal.

### SUMMARY

The embodiments of the present invention are directed to an apparatus that satisfies the needs set out in the Background section.

The embodiments of the present invention comprise: a collar for mounting around the neck of an animal, the collar comprising: two concentric disks of resilient material cut to form a truncated cone, the disks each having two faces, one face of one disk joined to one face of the other disk by a plurality of radially sewn seams, each disk having a curvilinear central aperture, the two apertures lined up with each other when the faces are joined such that the two apertures form a neck hole for receiving the neck of an animal; a drawstring-retaining passage around the neck hole and an opening out of the passage on one side of the neck hole, the passage formed by a rectangular sheet of soft, flexible and non-resilient material, the sheet having a central longitudinal axis and two marginal edges parallel to the longitudinal axis, the sheet folded over along the central longitudinal axis and joined at the marginal edges, the marginal edges joined to the disks along the neck hole; an elongated drawstring composed of resiliently stretchable, elastic fabric disposed in the passage and having opposite end portions extending out of the passage through the opening; an internal frame comprising a curvilinear C-shaped hub and a plurality of substantially rigid straight ribs monolithically radially extending from the curvilinear hub, the plurality of straight ribs and the hub defining a plane, the internal frame disposed between the two disks, the plurality of substantially rigid straight ribs held stationary by the plurality of radially sewn seams; and the disks having approximately the same radial width sufficient to extend outwardly from the neck of the animal immediately behind its head and lie between the head and mouth and parts of the animal's body when the animal attempts to reach those parts with its mouth.

In an alternate embodiment, the resilient material is selected from the group consisting of textile, fabric, cloth and nylon.

In an alternate embodiment, the resilient material is selected from the group consisting of polyethylene, polypropylene, copolymers of polyethylene and polypropylene, polytetrafluoroethylene, acrylonitrile butadiene styrene, polyvinylchloride, ethylene vinyl acetate and polystyrene.

In an alternate embodiment, the internal frame is made of a polymer selected from the group consisting of polyethylene, polypropylene, copolymers of polyethylene and polypropylene, polytetrafluoroethylene, acrylonitrile butadiene styrene, polyvinylchloride, ethylene vinyl acetate and polystyrene.

In an alternate embodiment, the marginal edges of the drawstring-retaining passage are joined to the disks along the neck hole by a sewn seam.

### SOME ADVANTAGES OF THE EMBODIMENTS OF THE INVENTION

In the embodiments of the present invention, the internal frame prevents the collar from collapsing. By adjusting the size at which it is made, the collar can be adapted for use with many types of animals.

These and other advantages will become apparent as the embodiments of the invention are used.

### DRAWINGS

These and other features, aspects and advantages of the embodiments of the device and/or methods will become better understood with reference to the following description, appended claim and accompanying drawings where:

FIG. 1 shows a plan view of one disk of the animal medical collar;

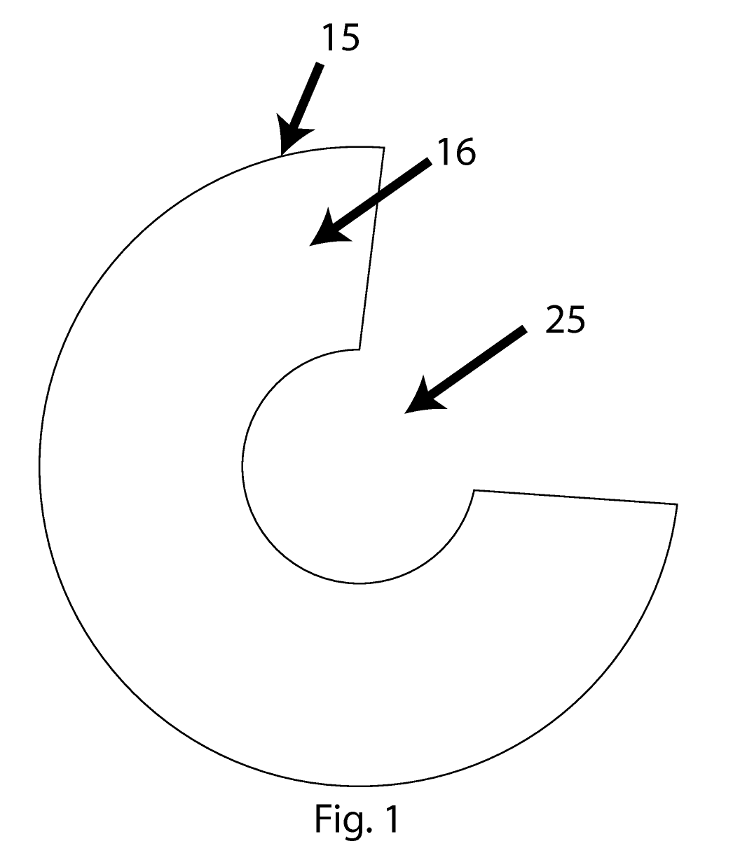

FIG. 2 shows a plan view of the internal frame;

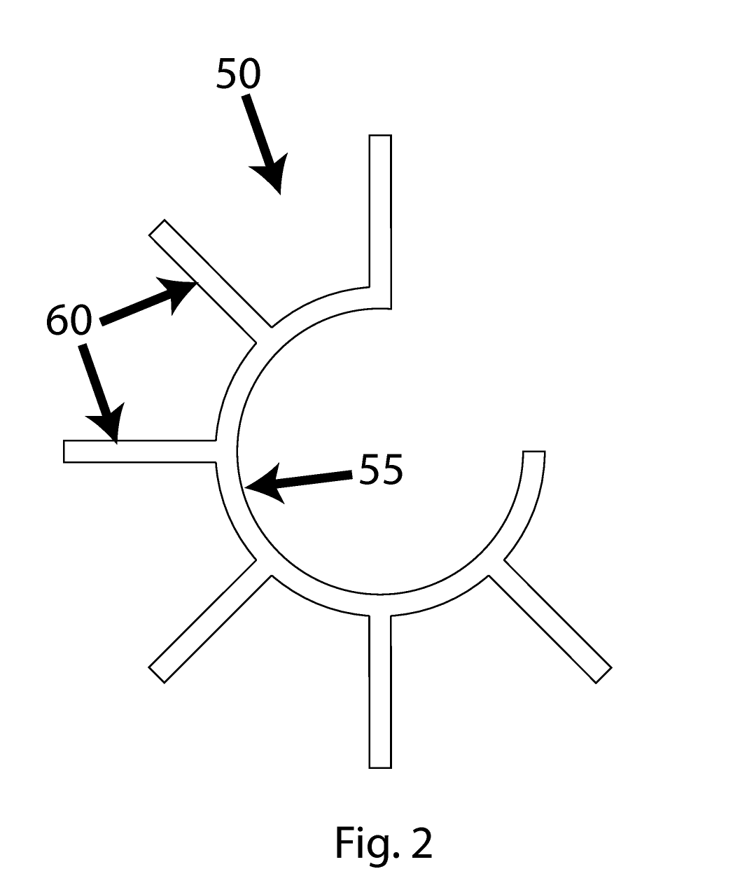

FIG. 3 shows a plan view of the drawstring-retaining passage prior to sewing;

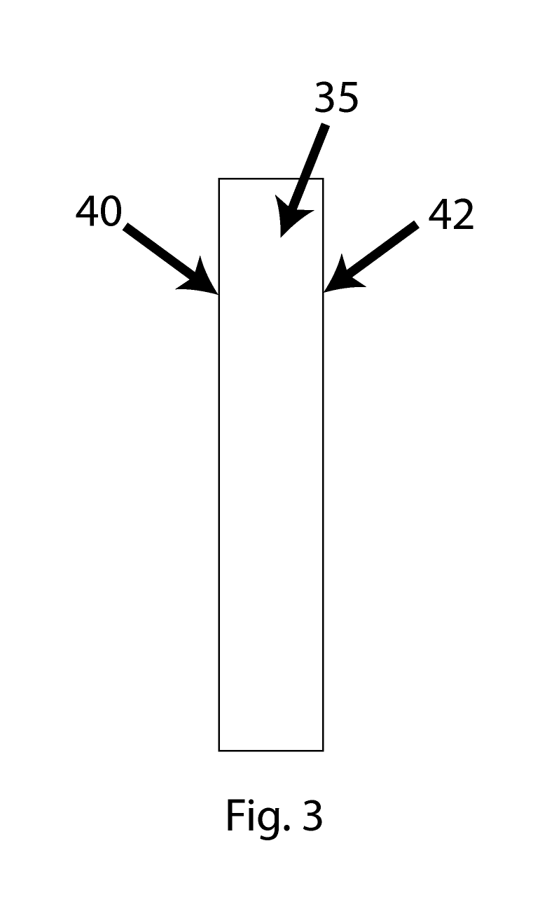

FIG. 4 shows a plan view of the opposite side of one disk of the animal medical collar;

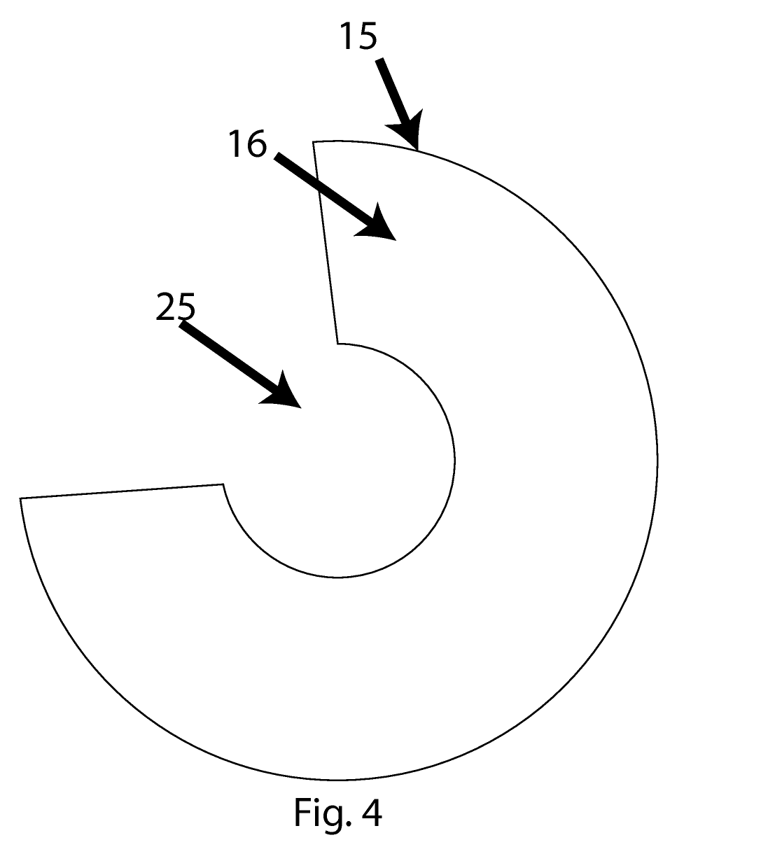

FIG. 5 shows a perspective view of the device fitted to a cat.

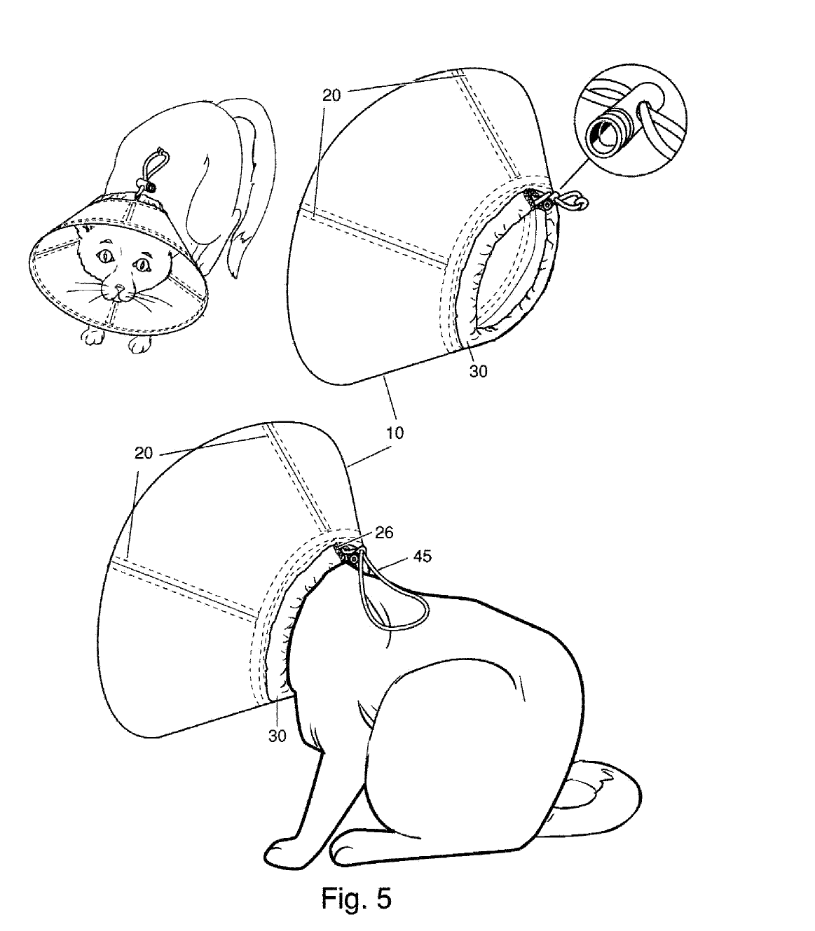

### REFERENCE NUMERALS FOR DRAWINGS

10 collar
15 disk(s)
16 face
20 radially sewn seams
25 curvilinear central aperture, neck hole
26 opening
30 drawstring-retaining passage
35 sheet
40 marginal edge
45 drawstring
50 internal frame
55 hub
60 rib
65 sewn seam

### DESCRIPTION

### Definitions

“Fabric” as used herein refers to textile, fabric and cloth, in the broadest and most inclusive sense possible. As stated in Wikipedia (http://en.wikipedia.org/wiki/Textile): “A textile is a flexible material consisting of a network of natural or artificial fibres often referred to as thread or yarn. Yarn is produced by spinning raw wool fibres, linen, cotton, or other material on a spinning wheel to produce long strands known as yarn. Textiles are formed by weaving, knitting, crocheting, knotting, or pressing fibres together (felt).

“The words fabric and cloth are used in textile assembly trades (such as tailoring and dressmaking) as synonyms for textile. However, there are subtle differences in these terms in specialized usage. Textile refers to any material made of interlacing fibres. Fabric refers to any material made through weaving, knitting, crocheting, or bonding. Cloth refers to a finished piece of fabric that can be used for a purpose such as covering a bed.” Thus ceramic fabric made from ceramic thread is a textile; and a fabric made from inorganic metallic thread is a textile; but both are “fabric” for the purposes herein. Polyester and cotton both may be made into fabric, and there are many fabrics that are blends of polyester and cotton. Many types of fabric are blends of silk, cotton, linen, wool and worsted. Fabric can be organic or inorganic or combinations thereof, natural or synthetic or combinations thereof. Nylon fibers can be used to make a fabric. Fabric refers to uncoated fabric, unless explicitly modified by the precursor “coated,” as in “coated fabric.”

Disks are sheets of material, comparable to sheets of paper or sheets of paperboard or sheets of cardboard or sheets of thin lumber. Just as a sheet of paper has two sides or two faces, a disk has two sides or two faces.

### DESCRIPTION OF THE PREFERRED EMBODIMENT AND BEST MODE

As shown in the figures, the preferred embodiment and best mode of the present invention comprises: a collar 10 for mounting around the neck of an animal, the collar 10 comprising: two concentric disks 15 of resilient material cut to form a truncated cone, the disks 15 each having two faces 16, one face 16 of one disk 15 joined to one face 16 of the other disk 15 by a plurality of radially sewn seams 20, each disk 15 having a curvilinear central aperture 25, the two apertures 25 lined up with each other when the faces 16 are joined such that the two apertures 25 form a neck hole 25 for receiving the neck of an animal; a drawstring-retaining passage 30 around the neck hole 25 and an opening 26 out of the passage on one side of the neck hole 25, the passage 30 formed by a rectangular sheet 35 of soft, flexible and non-resilient material, the sheet 35 having a central longitudinal axis and two marginal edges 40 parallel to the longitudinal axis, the sheet 35 folded over along the central longitudinal axis and joined at the marginal edges 40, the marginal edges 40 joined to the disks 15 along the neck hole 25; an elongated drawstring 45 composed of resiliently stretchable, elastic fabric disposed in the passage 30 and having opposite end portions extending out of the passage 30 through the opening 26; an internal frame 50 comprising a curvilinear C-shaped hub 55 and a plurality of substantially rigid straight ribs 60 monolithically radially extending from the curvilinear hub 55, the plurality of straight ribs 60 and the hub 55 defining a plane, the internal frame 50 disposed between the two disks 15, the plurality of substantially rigid straight ribs 60 held stationary by the plurality of radially sewn seams 20; and the disks 15 having approximately the same radial width sufficient to extend outwardly from the neck of the animal immediately behind its head and lie between the head and mouth and parts of the animal's body when the animal attempts to reach those parts with its mouth.

In an alternate embodiment, the resilient material is selected from the group consisting of textile, fabric, cloth and nylon.

In an alternate embodiment, the resilient material is selected from the group consisting of polyethylene, polypropylene, copolymers of polyethylene and polypropylene, polytetrafluoroethylene, acrylonitrile butadiene styrene, polyvinylchloride, ethylene vinyl acetate and polystyrene.

In an alternate embodiment, the internal frame 50 is made of a polymer selected from the group consisting of polyethylene, polypropylene, copolymers of polyethylene and polypropylene, polytetrafluoroethylene, acrylonitrile butadiene styrene, polyvinylchloride, ethylene vinyl acetate and polystyrene.

In an alternate embodiment, the marginal edges 40 of the drawstring-retaining passage 30 are joined to the disks 15 along the neck hole 25 by a sewn seam 65.

Some advantages of the embodiments of the apparatus were previously enumerated in the Summary section. Every advantageous feature does not need to be incorporated into every embodiment of the apparatus and/or methods.

Although these versions of the invention have been described in considerable detail, other versions are possible. For example, embodiments can comprise combinations of the features described herein, such as combinations of the dependent claims. Therefore, the spirit and scope of the appended claims should not be limited to the description of the versions contained therein.

I claim:

1. A collar for mounting around the neck of an animal, the collar comprising:
A. two concentric disks of resilient material cut to form a truncated cone, the disks each having two faces, one face of one disk joined to one face of the other disk by a plurality of radially sewn seams, each disk having a curvilinear central aperture, the two apertures lined up with each other when the faces are joined such that the two apertures form a neck hole for receiving the neck of an animal;
B. a drawstring-retaining passage around the neck hole and an opening out of the passage on one side of the neck hole, the passage formed by a rectangular sheet of soft, flexible and non-resilient material, the sheet having a central longitudinal axis and two marginal edges parallel to the longitudinal axis, the sheet folded over along the central longitudinal axis and joined at the marginal edges, the marginal edges joined to the disks along the neck hole;
C. an elongated drawstring composed of resiliently stretchable, elastic fabric disposed in the passage and having opposite end portions extending out of the passage through the opening;
D. an internal frame comprising a curvilinear C-shaped hub and a plurality of substantially rigid straight ribs monolithically radially extending from the curvilinear hub, the plurality of straight ribs and the hub defining a plane, the internal frame disposed between the two disks, the plurality of substantially rigid straight ribs held stationary by the plurality of radially sewn seams; and
E. the disks having approximately the same radial width sufficient to extend outwardly from the neck of the animal immediately behind its head and lie between the head and mouth and parts of the animal's body when the animal attempts to reach those parts with its mouth.

2. The device of claim 1, wherein the resilient material is selected from the group consisting of textile, fabric, cloth and nylon.

3. The device of claim 1, wherein the resilient material is selected from the group consisting of polyethylene, polypropylene, copolymers of polyethylene and polypropylene, polytetrafluoroethylene, acrylonitrile butadiene styrene, polyvinylchloride, ethylene vinyl acetate and polystyrene.

4. The device of claim 1, wherein the internal frame is made of a polymer selected from the group consisting of polyethylene, polypropylene, copolymers of polyethylene and polypropylene, polytetrafluoroethylene, acrylonitrile butadiene styrene, polyvinylchloride, ethylene vinyl acetate and polystyrene.

5. The device of claim 1, wherein the marginal edges of the drawstring-retaining passage are joined to the disks along the neck hole by a sewn seam.
